(19) United States
(12) Patent Application Publication
(10) Pub. No.: US 2006/0202637 A1
(43) Pub. Date: Sep. 14, 2006

(54) DRIVING CIRCUIT AND METHOD OF TUNING A DRIVING VOLTAGE OF A LIGHT-EMITTING DEVICE UTILIZING A FEEDBACK MECHANISM

(76) Inventors: Yung-Hsin Chiang, Taipei Hsien (TW); Yi-Mei Li, Nan-Tou Hsien (TW)

Correspondence Address: NORTH AMERICA INTELLECTUAL PROPERTY CORPORATION, P.O. BOX 506, MERRIFIELD, VA, 22116, US

(21) Appl. No.: 11/306,550

(22) Filed: Jan. 2, 2006

(30) Foreign Application Priority Data
Mar. 8, 2005 (TW) 094106949

(51) Int. Cl. H05B 41/36

(52) U.S. Cl. 315/291

(57) ABSTRACT

A driving circuit and method for driving a light-emitting device. The driver circuit includes a first bias circuit coupled to an output node of a first light-emitting device for providing a bias current to the first light-emitting device; and a voltage regulator coupled to an input node of the first light-emitting device and the output node of the first light-emitting device for providing a driving voltage to the first light-emitting device and adjusting the driving voltage according to a voltage level of the output node.

### BACKGROUND OF THE INVENTION

1. Field of the Invention

The invention relates to a circuit and method for driving a light-emitting device, and more particularly, to a driving circuit and method of tuning a driving voltage of a light-emitting device utilizing a feedback mechanism.

2. Description of the Prior Art

Recently, the Light Emitting Diode (LED) application field has been constantly changing and developing. Different from the general incandescent light bulb, the light emitting diode functions as cold-radiation device. Inasmuch, the LED offers a variety of advantages, such as: low power consumption, long utilization life span, no warm-up time, and fast reaction time. Moreover, resulting from other characteristics of LEDs, like: small volume, shock resistance, and suitability for large-scope manufacture, the light emitting diode is easily applied to the many design requirements that call for smaller or array type components. Hence, the light emitting diode has enjoyed general utilization as an indicator light and device monitor in information, communication, and consumer electronic products. Specifically, LEDs are applied in portable products, such as being the backlight source for the display screen of mobile phones, personal digital assistants (PDAs), and are especially popular for use in liquid crystal display products. The result is that these factors cause the light emitting diode to be one of the most indispensable key components in use today. Finally, LEDs are frequently applied in various outdoor monitor and traffic signals.

Since the application of the light emitting diodes is tremendously vast, it has become very important issue to consider how to design more stable driving circuits for light emitting diodes. Please refer to FIG. 1. FIG. 1 is a block diagram of a conventional driving circuit 100. As shown in FIG. 1, the driving circuit 100 includes a voltage regulator circuit 102 and a current source 104. The voltage regulator circuit 102 provides a driving voltage V_{d} to a light-emitting device 106. Additionally, the current source 104 provides a driving current I_{b} for driving the light-emitting device 106. In other words, the current source 104 can dynamically adjust the amount of luminance of the light-emitting device 106 according to adjustments in the current value of the driving current I_{b}. As shown in FIG. 1, the light-emitting device 106 includes a plurality of light emitting diodes 108. Note that each light emitting diode 108 is referred to as a current driven device. Also, the luminance of the light emitting diode is in direct proportion to the driving current. That is, the luminance of the light emitting diode 108 increases as the driving current increases and the two increases in direct proportion to one another. In general, to achieve a uniform luminance of the plurality of light emitting diodes 108 it is a matter of driving each current of the plurality of light emitting diodes 108 is a same current. To achieve the requirement of uniform luminance, the light emitting diodes 108 will be coupled in a series. That is, as more light emitting diodes 108 are coupled, the required forward bias voltage V_{f} of the light-emitting device 106 grows. Therefore, the voltage regulator circuit 102 must provide more driving voltage V_{d} to supply the required forward bias voltage V_{f} of the light-emitting device 106.

However, due to limitations of the material and the manufacturing process used for LEDs, the required forward bias current of each light emitting diode 108 is not identical. For example, consider that the light-emitting device 106 includes three light emitting diodes 108. As is known, the required forward bias current of each light emitting diode 108 is not identical. Obviously, the voltage regulator circuit 102 cannot be acquainted with the proper driving voltage V_{d} of the light-emitting device 106 in advance. Accordingly, if the driving voltage V_{d} provided by the voltage regulator circuit 102 is overloading (V_{d}>>V_{f}), the voltage difference (V_{d}−V_{f}) of the redundant voltage will enlarge the power consumption of the current source 104 and lead to a reduced the life span of the current source 104. Additionally, if the driving voltage V_{d} provided from the voltage regulator circuit 102 is under loading, the voltage difference between two nodes of the light-emitting device 106 will be insufficient to drive the light-emitting device 106.

### SUMMARY OF THE INVENTION

It is therefore one of the many objectives of the claimed invention to provide a driving circuit and method of tuning a driving voltage of a light-emitting device utilizing a feedback mechanism for solving the above-mentioned problem.

According to an aspect of the present invention, a driving circuit for driving a light-emitting device is disclosed. The driving circuit comprising: a first bias circuit coupled to an output node of a first light-emitting device for providing a first bias current to the first light-emitting device;and a voltage regulator circuit coupled to an input node of the first light-emitting device and the output node of the first light-emitting device for providing a driving voltage to the first light-emitting device and adjusting the driving voltage according to a voltage level of the output node.

According to another aspect of the present invention, a method for driving at least a light-emitting device is disclosed. The method comprising: (a) providing a first bias circuit coupled to an output node of a first light-emitting device for providing a first bias current to the first light-emitting device;(b) providing a driving voltage to a input node of the first light-emitting device; and (c) adjusting the driving voltage according to a voltage level of the output node.

The driving circuit of the present invention is utilizing a current sink as a bias circuit to control the driving current passing through a light-emitting device (which includes at least a light-emitting diode). Moreover, the voltage regulator unit of the driving circuit in the present invention includes a comparator for outputting a control signal to the voltage regulator unit according to the voltage level of the output node of light-emitting device. And the voltage regulator unit tunes the driving voltage, which is inputted to the input node of the light-emitting device according to the control signal. Therefore, by appropriately adjusting the driving voltage can reduce the original cross voltage between two nodes of the bias circuit to reduce the power consumption and extend the utilization life span. In addition, the driving circuit of the present invention also can be utilized for driving a plurality of light-emitting devices, and the driving circuit of the present invention also includes a selection circuit for selecting a minimum voltage level (which is corresponding to the largest forward bias voltage of the light-emitting devices) among a plurality of voltage levels from the output nodes of the light-emitting devices to proceed the following tuning process, which also achieve the object of reducing the cross voltage between two nodes of the bias circuit to reduce the power consumption and extend the utilization life span.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a conventional driving circuit.

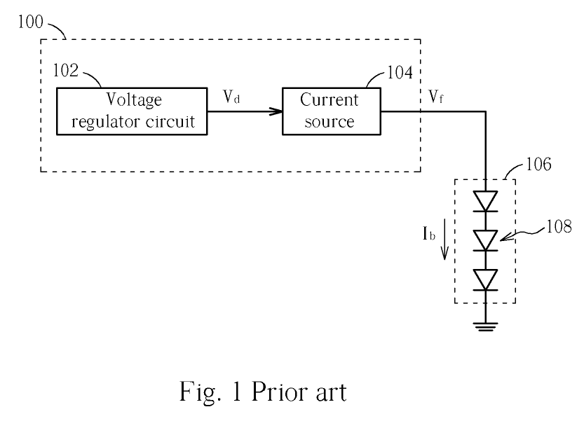

FIG. 2 is a block diagram of the driving circuit according to a first embodiment of the present invention.

FIG. 3 shows a flowchart describing an embodiment of the driving circuit tuning the driving voltage V_{DD} shown in FIG. 2.

FIG. 4 is a block diagram of the driving circuit according to a second embodiment of the present invention.

FIG. 5 shows a flowchart describing an embodiment of the driving circuit tuning the driving voltage V_{DD} shown in FIG. 4.

### DETAILED DESCRIPTION

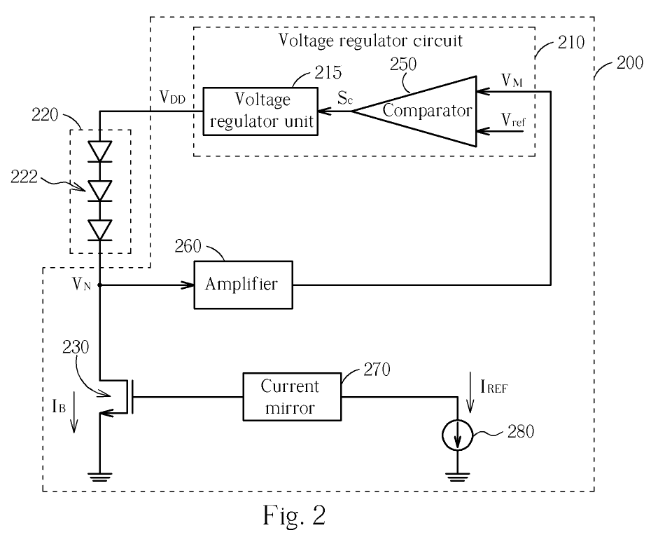

Please refer to FIG. 2. FIG. 2 is a block diagram of the driving circuit 200 according to a first embodiment of the present invention. The driving circuit 200 is utilized to drive a light-emitting device 220. For this preferred embodiment, the light-emitting device 220 includes a plurality of light-emitting diodes 222, however, the light-emitting device 220 in this present invention is not limited to including a plurality of light-emitting diodes in a series. That is, the light-emitting device 220 also can also include a single light-emitting diode. Moreover, the light-emitting device 220 is also not limited to the composition of light-emitting diodes (i.e., other compositions also obey the sprit of the present invention). As shown in FIG. 2, the driving circuit 200 primarily includes a voltage regulator circuit 210 and a bias circuit 230. The voltage regulator circuit 210 includes a comparator 250 and a voltage regulator unit 215. The voltage regulator unit 215 is utilized to provide a driving voltage V_{DD} to the light-emitting device 220 and for dynamically adjusting the driving voltage V_{DD} according to a control signal S_{c} outputted from the comparator 250. In general, the voltage regulator circuit 210 can be implemented by any conventional power supply or driving chip of the light-emitting device, that is, the voltage regulator circuit 210 can output the desired driving voltage V_{DD} according to an alternating current source or a direct current source. In addition, for this preferred embodiment, the driving circuit 200 further includes an amplifier 260, however, for other preferred embodiments, an amplifier 260 is not necessarily required to be disposed in the driving circuit 200.

The operation of the driving circuit 200 tuning a driving voltage V_{DD} utilizing a feedback mechanism is described as follows. Assume that the forward bias voltage (i.e., a voltage drop) needed by the light-emitting device 220 is V_{F}. Please note that the light-emitting device 220 includes at lease one light-emitting diode 222, and that as the number of light-emitting diodes 222 increases an additional and proportional amount of forward voltage is required by the light-emitting device 220 (i.e., more V_{F}). On the other hand, since the forward voltage of each individual light-emitting diode 222 is not identical, when the individual light-emitting diode of the light-emitting device 220 is replaced, or the number of the light-emitting diodes 222 is increasing or decreased (i.e., changed), the value of the forward bias V_{F} will be changed. As mentioned above, the voltage regulator circuit 210 provides a driving voltage V_{DD} to the input node of the light-emitting device 220. If the driving voltage V_{DD} is sufficient to drive the light-emitting device 220, the voltage level V_{N} corresponding to the input node of the light-emitting device 220 can be considered to be the result of subtracting the forward bias voltage V_{F} corresponding to the light-emitting device 220 from the driving voltage V_{DD}, which can be expressed as follows:
V_{N}=V_{DD}−V_{F} Formula 1

In this preferred embodiment, the bias circuit 230 is referred to as a current sink for drawing a bias current I_{B} from the light-emitting device 220 (i.e., the driving current of the light-emitting device 220). As shown in FIG. 2, the bias circuit 230 is composed of an N-channel metal oxide semiconductor transistor (i.e., an NMOS transistor), the drain node of the NMOS transistor is coupled to the input node of the light-emitting device 220; the source node of the NMOS transistor is coupled to the ground node; and the gate node of the NMOS transistor is coupled to a current mirror 270. A reference current source 280 is coupled to one end of the current mirror 270 for providing a reference current I_{REF}, thus the current mirror 270 drives the bias circuit 230 to produce the bias current I_{B} according to a current mirror ratio and the reference current I_{REF}. For example, assuming that the current mirror ratio is M, thereby the relationship between the bias current I_{B} and the reference current I_{REF} can be indicated as follows:

I_{B}=M*I_{REF} Formula 2

Please note that, although the above-mentioned bias circuit 230 is composed of the N-channel metal oxide semiconductor transistor, the N-channel metal oxide semiconductor transistor is merely an example utilized in the present embodiment of the present invention. For example, the bias circuit in the present invention is not limited to the N-channel metal oxide semiconductor transistor, in fact, in another exemplary embodiment; the bias circuit 230 can be composed of another device, for example, bipolar junction transistors, and the effect and function is the same. Additionally, since the practical circuit structure and operation of the current mirror 270 and the reference current source 280 is considered well known in the pertinent art, a detailed description is omitted here for the sake of brevity. The bias circuit 230 is referred to as a current sink; therefore, the voltage level V_{N} is perceived as the voltage drop of the bias circuit 230. As mentioned above, if the output voltage of the voltage regulator circuit 210 is adjusted inappropriately, the overloading driving voltage V_{DD} Will significantly increase the voltage drop of the bias circuit 230, thus resulting in an increased power consumption in the bias circuit 230. Therefore, the driving circuit 200 of the present invention is utilizing a feedback mechanism to tune the output voltage (i.e., the driving voltage V_{DD}) of the voltage regulator circuit 210. The operation is described in the following paragraphs.

In general, the voltage level V_{N} is quite low. To prevent situations where low voltage level of V_{N} causes the comparator 250 of the voltage regulator circuit 210 to make erroneous determinations, the voltage level V_{N} will be amplified by the amplifier 260 to produce a magnification voltage level V_{M}. For example, the amplifier 260 will amplify the voltage level V_{N} as much as ten times to produce the voltage level V_{M}(e.g., V_{M}=10*V_{N}). Next, the comparator 250 compares the voltage level V_{M} to a reference voltage level V_{ref}. For this preferred embodiment, the value of the reference voltage level V_{ref} is related to the normal working voltage of the bias circuit 230. Assuming that the impedance of the bias circuit 230 is r, and further assume that when the bias circuit 230 conducts the bias current I_{B}, the voltage drop of the bias circuit 230 is at least I_{B}*r. Therefore, when the amplify gain of the amplifier 260 is 10, the reference voltage level V_{ref} will be set to 10*I_{B}*r. In other words, when the voltage level V_{M} is equal to the reference voltage level V_{ref}, namely the voltage level V_{N} will correspond to the minimum drop voltage within the bias current I_{B} conducted by the bias circuit 230. Therefore, in this situation, the unnecessary power consumption of the bias circuit 230 can be reduced. On the other hand, the amplify gain of the amplifier 260 can be predetermined according to the reference voltage level V_{ref} and the voltage level V_{N}. For example, in another embodiment, if the reference voltage level is a fixed value, the amplify gain of the amplifier 260 can be predetermined to be the ratio of the reference voltage level V_{ref} and the voltage level V_{N} (i.e., V_{ref}/V_{N}). Moreover, as will be apparent to a personal of ordinary skill in the art after reading this description, other embodiments of the present disclosure are also possible. Such as, adjusting the reference voltage level V_{ref} or the amplify gain of the amplifier 260 by another parameter, yet, the spirit of the intrinsic idea remains unchanged.

Regarding the comparator 250, if the voltage level V_{M} is larger than the reference voltage level V_{ref}, the comparator 250 will output a control signal S_{c} to the voltage regulator unit 215 for driving the voltage regulator unit 215 to increase the driving voltage V_{DD}. For example, the control signal S_{c} includes the difference information between the voltage level V_{M} and the reference voltage level V_{ref}, whereby the voltage regulator unit 215 can determine how to adjust the driving voltage V_{DD} according to the control signal S_{c}. Therefore, according to the control signal S_{c} from the comparator 250, the voltage regulator unit 215 eventually outputs a proper driving voltage V_{DD} utilizing the feedback control to drive the light-emitting device 220. Meanwhile, the driving voltage V_{DD} will eventually cause the voltage level V_{M} to equal the reference voltage level V_{ref}. Please note that, when the comparator 250 adjusts the driving voltage V_{DD} provided from the voltage regulator unit 215, regardless of the required forward voltage V_{F} of the light-emitting device 220, the problem that the voltage level V_{N} may be overload or under loaded will be solved by adjusting the driving voltage V_{DD} as per this present invention. To describe the detailed operation of the driving circuit 200 of the present invention, an example is utilized and illustrated as follows.

Please assume that the bias current I_{B} is 350 mA, and the impedance of the bias circuit 230 is roughly 0.714Ω. Namely, the minimum voltage drop of the bias circuit 230 is 0.25V. That is, in the optimal condition, the voltage level V_{N} should be equal to 0.25V to minimize the power consumption of the bias circuit 230. The reference voltage level V_{ref} is thus set to 2.5V (i.e., 10*0.25V). Given a situation where the initial value of the driving voltage V_{DD} provided by the voltage regulator unit 215 is equal to 14.5V and the light-emitting device 220 is composed of three light-emitting diodes 222 and the required forward voltage V_{F} for the light-emitting device 220 is about 14V it can be seen that the beginning voltage level V_{N} is equal to 0.5V (V_{DD}−V_{F}=14.5−14=0.5) and the voltage level V_{M} should be 5V. Since the voltage level V_{M} (5V) is larger than the reference voltage level V_{ref} (2.5V), the comparator 250 will output a control signal S_{c} to the voltage regulator unit 215 to reduce the driving voltage V_{DD} until the voltage level V_{M} is equal to the reference voltage level V_{ref}. Ultimately, the driving voltage V_{DD} will equal 14.25V.

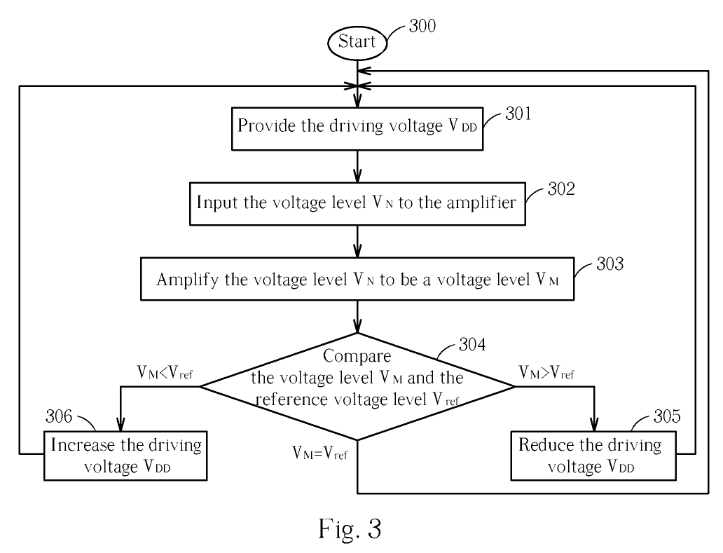

Please refer to FIG. 2 and FIG. 3 simultaneously. FIG. 3 shows a flowchart describing an embodiment wherein the driving circuit 200 is tuning the driving voltage V_{DD} shown in FIG. 2. Please note that, the related steps in the flowchart are not required to operate following this absolute sequence. It is possible for other steps can be inserted. The operation of the driving circuit 200 tuning the driving voltage V_{DD} is described below.

Step 300: Start.

Step 301: Provide a driving voltage V_{DD} to a light-emitting device 220.

Step 302: Input the voltage level V_{N} of the output node of the light-emitting device 220 to an amplifier 260.

Step 303: The amplifier 260 amplifies the voltage level V_{N} to produce a voltage level V_{M}.

Step 304: The comparator 250 compares the difference between the voltage level V_{M} and the reference voltage level V_{ref}. If the voltage level V_{M} is larger than the reference voltage level V_{ref}, proceed to step 305; if the voltage level V_{M} is smaller than the reference voltage level V_{ref}, proceed to step 306; and if the voltage level V_{M} is equal to the reference voltage level V_{ref}, return to step 301.

Step 305: The comparator 250 outputs a control signal S_{c} to control a voltage regulator unit 215 to reduce the driving voltage V_{DD}, return to step 301.

Step 306: The comparator 250 outputs a control signal S_{c} to control a voltage regulator unit 225 to increase the driving voltage V_{DD}, return to step 301.

Please note that, if the larger bias current I_{B} is utilized to increase the luminance of the light-emitting device 220, then the voltage level V_{N} will also be increased to a correspondingly higher voltage. Therefore, under this condition, the voltage level V_{N} will not necessary be amplified by the amplifier 260. That is, the comparator 250 can perform the procedures without amplifying the voltage level. For example, if the minimum voltage drop of the bias circuit 230 is 2.5V, then the reference voltage level V_{ref} can be directly determined as 2.5V. Accordingly, the comparator 250 then compares the voltage level V_{N} and the reference voltage level V_{ref} and outputs the control signal S_{c} to the voltage regulator unit 215 for tuning the driving voltage V_{DD} until an appropriate voltage value is achieved. Moreover, please note that in the driving circuit 200 shown in FIG. 2, the voltage regulator unit 215, the comparator 250, and the amplifier 260 are individual units. However, the amplifier 260 can be integrated into the voltage regulator circuit 210 or the comparator 250 can be in independent from the voltage regulator circuit 210. As will be apparent to a personal of ordinary skill in the pertinent art after reading this description, other embodiments of the present disclosure are also possible and a detailed description is omitted for the sake of brevity.

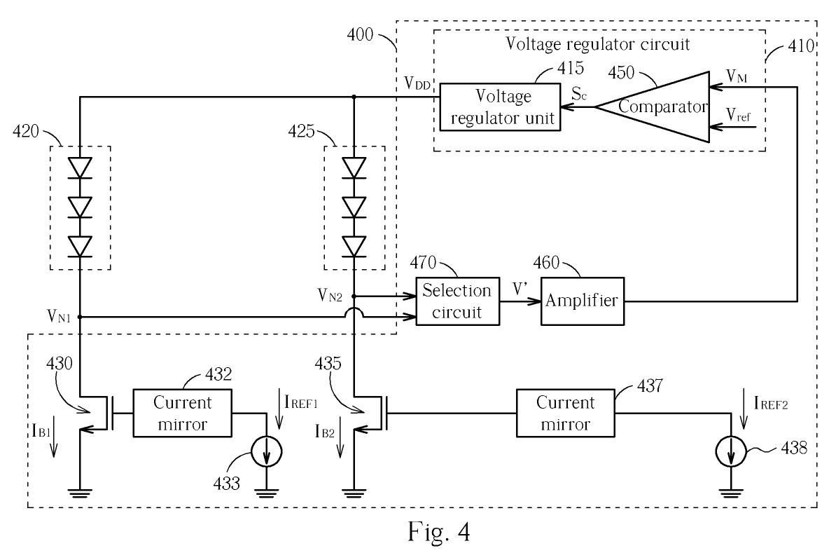

In the above-mentioned embodiment, the driving circuit 200 only drives a single light-emitting device 220, however, the driving circuit in the present invention is not limited to a certain number of light-emitting devices. Please refer to FIG. 4. FIG. 4 is a block diagram of the driving circuit 400 according to a second embodiment of the present invention. The driving circuit 400 is utilized to drive a plurality of light-emitting devices 420 and 425. Please note that, for convenience, only two light-emitting devices are shown in FIG. 4. The driving circuit 400 includes a voltage regulator circuit 410, a plurality of bias circuit 430 and 435, an amplifier 460, and a selection circuit 470. The bias circuit 430 and 435 are respectively coupled to the current mirror 432 and 437. And the current mirror 432 and 437 generate the bias current I_{B1} and I_{B2} according to the reference current I_{REF1} and I_{REF2} which are respectively provided by the reference current source 433 and 438. Additionally, the voltage regulator circuit 410 includes a comparator 450 and a voltage regulator unit 415. Please note that, elements having the same name in the FIG. 2 and FIG. 4 have the same function and operation, and therefore a detailed description is omitted for the sake of brevity. Although the voltage regulator circuit 410 provides the same driving voltage V_{DD} to the light-emitting device 420 and the light-emitting device 425, since the light-emitting device 420 and 425 may correspond to different forward bias voltage V_{F}, the voltage level V_{N1} of the light-emitting device 420 and the voltage level V_{N2} of the light-emitting device 425 will be different. In this embodiment, the driving circuit 400 utilizes the selection circuit 470 for selecting the smaller of the two voltage levels V_{N1} and V_{N2} to output a minimum voltage level V′ to the amplifier 460. That is, to reduce the power consumption for each bias circuit 430 and 435, and to ensure that the light-emitting device 420 and 425 can operate smoothly, the selection circuit 470 thus selects the smaller of the two voltage levels of the voltage levels V_{N1} and V_{N2} to be a minimum voltage level V′ (which are respectively corresponding to the biggest forward bias voltage of the voltage level V_{N1} and V_{N2}) to proceed with the tuning.

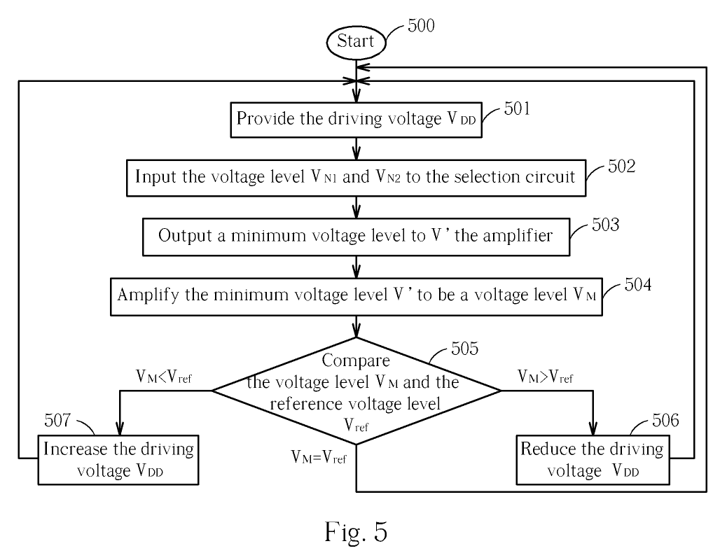

Please refer to FIG. 4 and FIG. 5 simultaneously. FIG. 5 shows a flowchart describing an embodiment of the driving circuit 400 tuning the driving voltage V_{DD} shown in FIG. 4. Please note that, the related steps in the flowchart are not required to operate following this precise sequence; other steps can be inserted. The operation of the driving voltage V_{DD} is described as follows.

Step 500: Start.

Step 501: Provide a driving voltage V_{DD} to the light-emitting device 420 and 425.

Step 502: Input the voltage level V_{N1} and V_{N2} of the output node of the light-emitting device 420 and 425 to a selection circuit 470.

Step 503: The selection circuit 470 outputs a minimum voltage level V′ where the minimum voltage level V′ is the smaller of the two voltage levels V_{N1} and V_{N2} to an amplifier 460.

Step 504: The amplifier 460 amplifies the minimum voltage level V′ to produce a voltage level V_{M}.

Step 505: The comparator 450 compares the difference between the voltage level V_{M} and the reference voltage level V_{ref}. If the voltage level V_{M} is lager than the reference voltage level V_{ref}, proceed to step 506; if the voltage level V_{M} is smaller than the reference voltage level V_{ref}, proceed to step 507; if the voltage level V_{M} is equal to the reference voltage level V_{ref}, return to step 501.

Step 506: The comparator 450 outputs a control signal S_{c} to control a voltage regulator unit 415 to reduce the driving voltage V_{DD}, return to step 501.

Step 507: The comparator 450 outputs a control signal S_{c} to control a voltage regulator unit 415 to increase the driving voltage V_{DD}, return to step 501.

As will be apparent to a personal of ordinary skill in the related art after reading the description of the driving circuit 200 shown in FIG. 2, the operation of the driving circuit 400 shown in FIG. 4 can be conducted easily, therefore a detailed description is omitted here for the sake of brevity. Please note that, if the larger bias current I_{B1} and I_{B2} are utilized to increase the luminance of the light-emitting device 420 and 425, the voltage level V_{N1} and V_{N2} will also be increased to a correspondingly higher voltage. Therefore, under this condition, the minimum voltage level V′ where V′ is the smaller of the two voltage levels V_{N1} and V_{N2} will not necessary need to be amplified by the amplifier 260. That is, the comparator 250 can perform the following procedures without amplifying the voltage level. For example, if the minimum voltage drop of the bias circuit 430 and 435 is 2.5V, then the reference voltage level V_{ref} can be directly determined as 2.5V. Accordingly, the comparator 450 then compares the voltage level V′ and the reference voltage level V_{ref} and outputs the control signal S_{c} to the voltage regulator unit 415 for tuning the driving voltage V_{DD} until an appropriate voltage value is achieved.

In contrast to the related art, the driving circuit of the present invention is utilizing a current sink as a bias circuit to control the driving current passing through a light-emitting device (which includes at least a light-emitting diode). Moreover, the voltage regulator unit of the driving circuit in the present invention includes a comparator for outputting a control signal to the voltage regulator unit according to the voltage level of the output node of light-emitting device. And the voltage regulator unit tunes the driving voltage, which is inputted to the input node of the light-emitting device according to the control signal. Therefore, by appropriately adjusting the driving voltage the present invention can reduce the original cross voltage between two nodes of the bias circuit to reduce the power consumption and extend the utilization life span. In addition, the driving circuit of the present invention also can be utilized for driving a plurality of light-emitting devices, and the driving circuit of the present invention also includes a selection circuit for selecting a minimum voltage level (which corresponds to the largest forward bias voltage of the light-emitting devices) among a plurality of voltage levels from the output nodes of the light-emitting devices to proceed with the tuning process, which also achieves the object of reducing the cross voltage between two nodes of the bias circuit to reduce the power consumption and extend the utilization life span.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A driving circuit for driving at least a light-emitting device, the driving circuit comprising:
a first bias circuit coupled to an output node of a first light-emitting device for providing a first bias current to the first light-emitting device; and
an amplifier coupled to the output node of the first light-emitting device for amplifying a voltage level corresponding to the output node of the first light-emitting device to generate an output voltage level according to an gain value; and
a voltage regulator circuit coupled to the amplifier and an input node of the first light-emitting device for providing a driving voltage to the first light-emitting device and for adjusting the driving voltage according to the output voltage level.

2. The driving circuit of claim 1, wherein the first light-emitting device comprises at least a light emitting diode (LED).

3. The driving circuit of claim 1, wherein the first bias circuit is a current sink.

4. The driving circuit of claim 1, wherein the voltage regulator circuit is further coupled to an input node of a second light-emitting device for providing the driving voltage to the second light-emitting device, and the driving circuit further comprises:
a second bias circuit coupled to a output node of the second light-emitting device for providing a second bias current to the second light-emitting device; and
a selection circuit coupled to the amplifier, the output node of the first light-emitting device and the output node of the second light-emitting device, for selecting a smallest voltage level among a voltage level corresponding to the output node of the first light-emitting device and a voltage level corresponding to the output node of the second light-emitting device to be a minimum voltage level and outputting the minimum voltage level to the amplifier.

5. The driving circuit of claim 4, wherein the first light-emitting device comprises at least a light emitting diode (LED) and the second light-emitting device comprises at least a light emitting diode (LED).

6. The driving circuit of claim 4, wherein the first bias circuit is a current sink and the second bias circuit is a current sink.

7. A method for driving at least a light-emitting device, the method comprising:
(a) providing a first bias current to an output node of the first light-emitting device;
(b) amplifying a voltage level corresponding to the output node of the first light-emitting device to generate an output voltage level according to an gain value; and
(c) providing a driving voltage to an input node of the first light-emitting device, and adjusting the driving voltage according to the output voltage level.

8. The method of claim 7, wherein the first light-emitting device comprises at least a light emitting diode (LED).

9. The method of claim 7, wherein the first bias circuit is a current sink.

10. The method of claim 7, wherein step (c) further comprises:
providing the driving voltage to an input node of a second light-emitting device;
step (a) further comprises:
providing a second bias current to an output node of the second light-emitting device; and
the method further comprises:
selecting a smallest voltage level among a voltage level corresponding to the output node of the first light-emitting device and a voltage level corresponding to the output node of the second light-emitting device to be a minimum voltage level and outputting the minimum voltage level to the amplifier.

11. The method of claim 10, wherein the first light-emitting device comprises at least a light emitting diode (LED) and the second light-emitting device comprises at least a light emitting diode (LED).

12. The method of claim 10, wherein the first bias circuit is a current sink and the second bias circuit is a current sink.
